(19) United States
(12) Patent Application Publication
(10) Pub. No.: US 2012/0214463 A1
(43) Pub. Date: Aug. 23, 2012

(54) DETECTING USE OF A MOBILE DEVICE BY A DRIVER OF A VEHICLE, SUCH AS AN AUTOMOBILE

(76) Inventors: Michael J. Smith, Seattle, WA (US); D. Redwood Stephens, Seattle, WA (US)

(21) Appl. No.: 13/290,126

(22) Filed: Nov. 6, 2011

Related U.S. Application Data
(60) Provisional application No. 61/410,828, filed on Nov. 5, 2010.
(60) Provisional application No. 61/431,845, filed on Jan. 12, 2011.

(51) Int. Cl. H04W 4/04; H04W 64/00

(52) U.S. Cl. 455/418; 455/26.1

(57) ABSTRACT

A system and method for detecting that a driver of a vehicle is using a mobile device is described. In some examples, the system uses information identifying a rate of speed of a vehicle and information identifying a location of a mobile device, such as information extracted from images taken of the vehicle and/or distance measurements performed within the vehicle, to determine whether a driver is using a mobile device.

### CROSS REFERENCE TO RELATED APPLICATIONS

The present application claims the benefit of U.S. Provisional Patent Application No. 61/410,828, filed on Nov. 5, 2010, entitled DETECTING USE OF A MOBILE DEVICE BY A DRIVER OF A VEHICLE, SUCH AS AN AUTOMOBILE, and U.S. Provisional Patent Application No. 61/431,845, filed on Jan. 12, 2011, entitled DETECTING USE OF A MOBILE DEVICE BY A DRIVER OF A VEHICLE, SUCH AS AN AUTOMOBILE, which are hereby incorporated by reference in their entirety.

### BACKGROUND

There is a general consensus that using a mobile device (such as by texting or conversing) impairs a driver's ability to effectively and/or safely control his/her automobile. Solutions have been proposed and implemented (e.g., solutions that inhibit use of a mobile device upon detecting a mobile device is moving at a certain speed), but these solutions suffer from various drawbacks. For example, they inhibit use of mobile devices by passengers of vehicles, they generate false positives, they require devices to be installed within a vehicle, and so on.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram illustrating components of a suitable mobile device.

FIG. 2 is a block diagram illustrating components of a device operation disablement component.

FIG. 3 is a flow diagram illustrating a routine for disabling operation of a mobile device based on image information.

FIGS. 4A-4D are screen displays illustrating image information utilized by the system.

FIG. 5 is a flow diagram illustrating a routine for disabling operation of a mobile device based on location detection.

The headings provided herein are for convenience only and do not necessarily affect the scope or meaning of the claimed system.

### DETAILED DESCRIPTION

A system for detecting use of a mobile device by an operator of a vehicle, such as a driver of an automobile, is described. In some embodiments, the system receives first information identifying a mobile device is within a moving vehicle, and receives second information identifying the mobile device is located in an area or region within the vehicle associated with an operator of the vehicle.

In some cases, the system receives, detects and/or captures image information to identify the location of the mobile device. The system may utilize one or more cameras of the mobile device to take one or more images of the surroundings of the mobile device, and, based on certain contents within the images (or absence of certain contents within the images), identify the location of the mobile device.

In some cases, the system receives, detects and/or captures distance information to identify the location of the mobile device. The system may utilize one or more distance measurement sensors and/or components of the mobile device to measure distances to various points within a vehicle, and, based on the measured distances, identify the location of the mobile device.

In some cases, the system utilizes other information to facilitate the identification of the location of the mobile device. The system may utilize information associated with the vehicle and its features, the orientation of the device, information associated with the manner in which user input is received via a touch-screen of the device, and so on.

In some cases, the system may collaborate with or be provided by an insurance company, mobile device company, telecommunications provider, or other entity. The system may periodically transmit information to an entity that verifies the system is functioning, and therefore has not been tampered with or disabled by a user. For example, an insurance company may provide the system to the company's customers, and give discounted monthly premiums upon validating use or operation of the system.

The system will now be described with respect to various embodiments. The following description provides specific details for a thorough understanding of, and enabling description for, these embodiments of the system. However, one skilled in the art will understand that the system may be practiced without these details. In other instances, well-known structures and functions have not been shown or described in detail to avoid unnecessarily obscuring the description of the embodiments of the system.

It is intended that the terminology used in the description presented below be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

### Suitable System

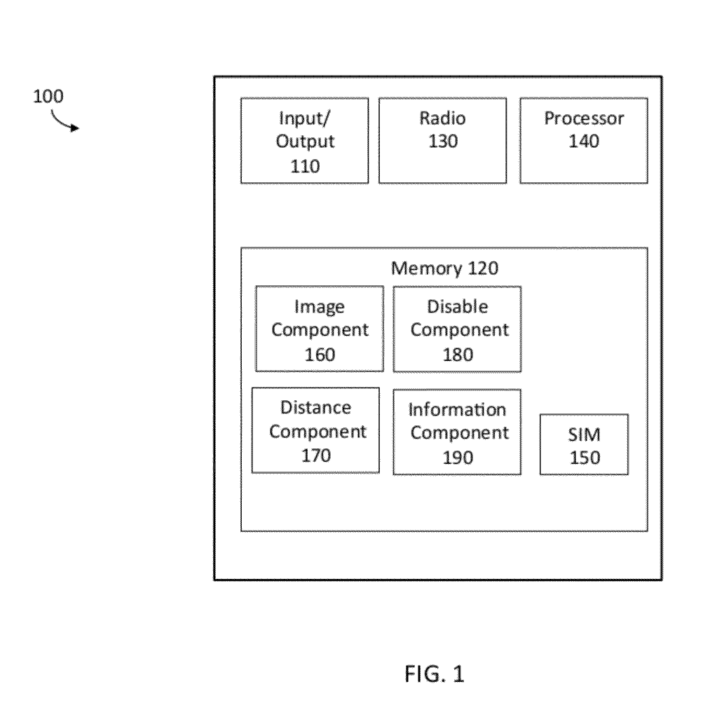

FIG. 1 illustrates a block diagram of a mobile device 100 on which the driver detection system and other routines or components can be supported. The mobile device 100 includes a user interface and other inputs and outputs (e.g., keypad, touch-based navigation components, microphone, speaker, visual display, and so on) 110, a memory 120, such as programmable non-volatile memory, and a radio component 130, or other communications component. Furthermore, the mobile device 100 includes a processor 140, which may receive and send transmitted signals from the radio 130, may receive signals from the user interface and various inputs 110, may transmit signals to the user interface 110, and so on. In some cases, the mobile device may include a microcontroller (which may be part of processor 140) containing a decoder, another processor, RAM (Random Access Memory), digital signal processor, and so on.

The mobile device also includes a subscriber identity module (SIM) 150, such as a SIM having a memory component and capable of storing applications, routines, and other processes that assist the mobile device in executing the routines described herein, such as routines that disable device operations upon detecting a driver is operating the device.

The mobile device 100 also includes a image component 160, such as a camera, imaging sensor, or other component capable of taking and/or recording visual information surrounding the mobile device 100, and a distance measurement component 170, such as a range finder, Bluetooth component, RFID, 2.4 GHz transceiver or other component capable of measuring a distance between the mobile device 100 and one or more points within or outside a vehicle. In some cases, the image component 160 may include the distance measurement component 170, or may be the distance measurement component 170 (not shown).

In addition, the mobile device 100 may include information capture components 180, such as an automated data collection unit linked to the processor 140, which can include an automated RFID (Radio Frequency Identification) tag reader, a GPS component, an accelerometer, an orientation sensor, and/or other information capture components. Other hardware components, such as media players and other output devices, can of course be included.

A device operation disablement component 190 may utilize various components contained by the mobile device 100 when determining an operator of a vehicle is using a mobile device. For example, the device operation disablement component 190 receives information from the information component 180 that identifies a vehicle is traveling at a certain rate of speed (e.g., a GPS component derives the distance traveled in a certain period of time), and receives information from the image component 160 that identifies the location of the mobile device 100 within the vehicle (e.g., a camera captures images of the steering column), and, based on the received information, disables operation of the mobile device 100.

FIG. 1 and the discussion herein provide a brief, general description of a suitable telecommunications or computing environment in which the system can be implemented. Although not required, aspects of the system are described in the general context of computer-executable instructions, such as routines executed by a general-purpose computer, e.g., a mobile device, a smart phone, a tablet computer, a server computer, or a personal computer. Those skilled in the relevant art will appreciate that the system can be practiced with other communications, data processing, or computer system configurations, including: Internet appliances, hand-held devices (including personal digital assistants (PDAs)), all manner of cellular or mobile phones, multi-processor systems, microprocessor-based or programmable consumer electronics, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media, such as tangible computer-readable storage media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

### Detecting Use of a Mobile Device by an Operator of a Vehicle

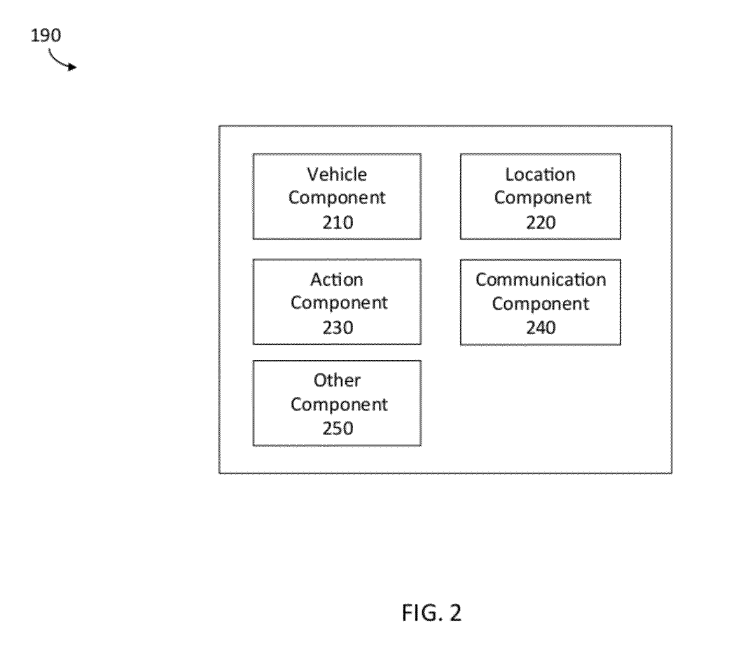

FIG. 2 is a block diagram illustrating components of a device operation component 190. The device operation component 190 includes a vehicle determination component 210 that determines whether a mobile device 100 is within a suitable moving vehicle, a location determination component 220 that determines whether the mobile device is within a certain location within the moving vehicle, an action component 230 that performs an action based on a determined location, a communication component 240 that receives or transmits information in or out of the system, such as to an entity providing the system, and other components, such as components that receive additional information to assist in determining the mobile device is moving in a vehicle or is in a certain location. Further details regarding these components will now be discussed.

The vehicle determination component 210 may utilize various components of a mobile device when determining a mobile device is within a moving vehicle. For example, the vehicle determination component may utilize information from a GPS component and/or accelerometer to determine a rate of speed of the mobile device, and when the determined rate of speed is above or within certain threshold speeds associated with the vehicle, determine the mobile device is within a vehicle. For example, the vehicle determination component 210 may make the determination when the mobile device is moving at a rate of speed between 20 miles per hour (32 km/hr) and 80 miles per hour (129 km/hr), or other ranges applicable to a moving vehicle such as a car or other automobile (e.g. above 10 miles per hour). The vehicle determination component 210 may adjust the threshold speeds based on a variety of factors, includes the location of a mobile device, applicable laws and/or statutes associated with illegal use of a mobile device, and so on.

In some examples, the vehicle determination component 210 may utilize other information to assist in determining the mobile device is within a suitable moving vehicle. For example, the vehicle determination component may use a mapping component to identify a route of travel for a vehicle in order to determine the vehicle is an automobile and not a train, bicycle, airplane, and so on.

In some examples, the location determination component 220 may utilize various components of a mobile device when determining a mobile device is located in a certain area within a vehicle associated with a driver of the vehicle. In some cases, the location determination component 220 may review images from an image component 160, identify certain content within the reviewed images as being associated with an area for the driver of the vehicle, and determine the mobile device is in a prohibited location based on the identified content. In some cases, the location determination component 220 may measure distances between the mobile device and various points within the vehicle, and determine the mobile device is in a prohibited location based on the measured distances.

In some examples, the action component 230 may perform various actions in response to receiving information from the vehicle determination component 210 and/or the location determination component 220. In some cases, the action component 230 performs an action that adjusts or modifies the operation of the mobile device. For example, the action may shut down the mobile device, disable operation of a texting application or functionality, disable operation of a calling application or functionality, inform a user of the determinations, warn or provide an alert to the user, update a log with information (e.g., with time and type of use information) about the use of the mobile device while the vehicle is in motion, engage with Bluetooth enabled devices, such as car kits, communicate with other mobile devices within the vehicle (e.g., transmit inbound text messages or calls to passenger devices), enable use of the mobile device or applications, and so on.

In some examples, the communication component 240 may receive and/or transmit information and other data in or out of the mobile device. In some cases, the communication component 240 may, in response to receiving an indication that a driver is using an application of the mobile device while a vehicle is moving, log or otherwise track the use, including the time of day, location, rate of speed, and so on. In some cases, an entity, such as an insurance company, may ping or otherwise transmit and/or retrieve information from the device via the communication component 240, such as information indicating a user of the mobile device has not disabled or otherwise stopped use of the system.

In some examples, the location determination component 220 may utilize information from various other components 250 that assists in determining a mobile device is located in a certain area within a vehicle associated with a driver of the vehicle. In some cases, the information may include orientation information, such as information from a compass, that complements information from the image component 160, use information, such as information associated with how information is received from a user via a touch-screen of the mobile device (i.e., information identifying how a device is held, how many fingers are entering information, the angle of a finger on the touch-screen, and so on), and other information.

In some cases, the location determination component 220 may utilize information associated with a vehicle or its features, such as information that identifies the vehicle (e.g., make, model, year, and so on). This information may be received from a variety of sources, such as a user of the system, an entity providing the system, and so on. Having knowledge of such information, the location determination component 220 may retrieve or receive images associated with the vehicle, such as images of interior locations and components of the vehicle, and use these images when attempting to match images surrounding a mobile device with images representative of a location associated with a driver of the vehicle, among other things.

Further details regarding routines performed by various components described herein will now be discussed.

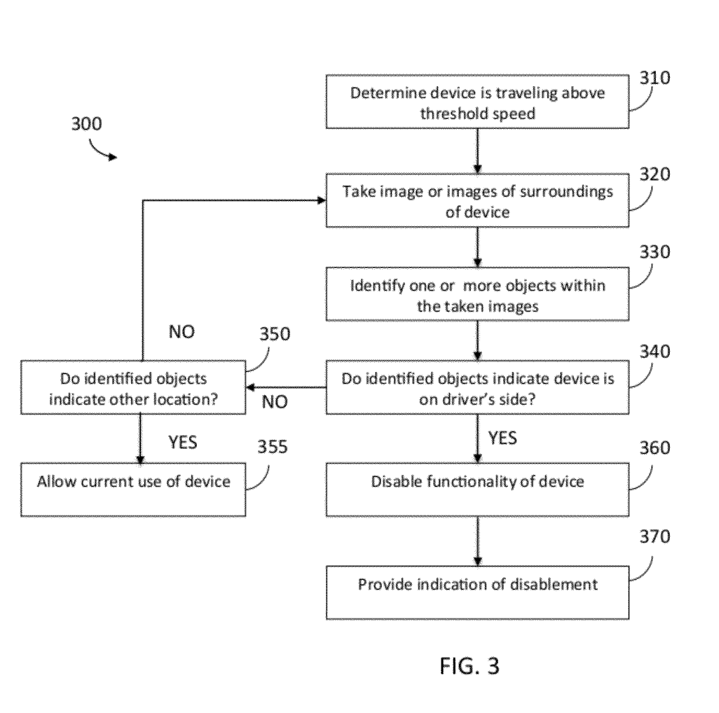

FIG. 3 is a flow diagram illustrating a routine 300 for disabling operation of a mobile device based on image-based location information. In step 310, the system, via a vehicle determination component 210, determines a mobile device is traveling above or within a threshold rate of speed. In step 320, the system, via a location determination component, takes or captures images of the surroundings of the device, such as images of interior features of the vehicle.

In step 330, the system identifies objects within the captured images. Alternatively, the system may identify the absence of certain objects within the captured images. The system may utilize a variety of different image search or identification systems and associated techniques, such as content-based image retrieval (CBIR) systems. For example, in some cases, the system may employ a “query by example” technique that extracts a shape or object from a captured image and uses the extracted shape or object to search for matching images. Other techniques utilized by the system may include image distance measurement and/or filtering techniques (e.g., using color, texture, shape, and so on match images), semantic retrieval techniques, and other known query methods. For example, in some cases, the system, upon receiving a set of captured images, may follow pre-specified instructions, such as an instruction to “look for a steering wheel or dashboard,” among other things.

In step 340, the system determines if the identified objects, or the identified absence of objects, indicate the mobile device is within a location associated with the driver of the vehicle. For example, if a vehicle is split into four quadrants, the system may determine the mobile device is within the upper left quadrant of the vehicle.

The system may consider images of a number of different objects to be indicative of a location associated with a driver. Some of these objects include: a steering column, dashboard elements, light versus dark contrasts on a dashboard (i.e., when driving during the night or when a vehicle's lights are on), moving elements on a dashboard, a GPS or other attached device, a radio, objects specifically placed on or within the interior of the vehicle, such as indicia, patterns, bar codes, or other information, and so on. In some cases, the location of the objects within the images, such as in relation to other objects or features within the vehicle, other objects or features outside of the vehicle, and so on, may indicate that a mobile device is in a location associated with a driver.

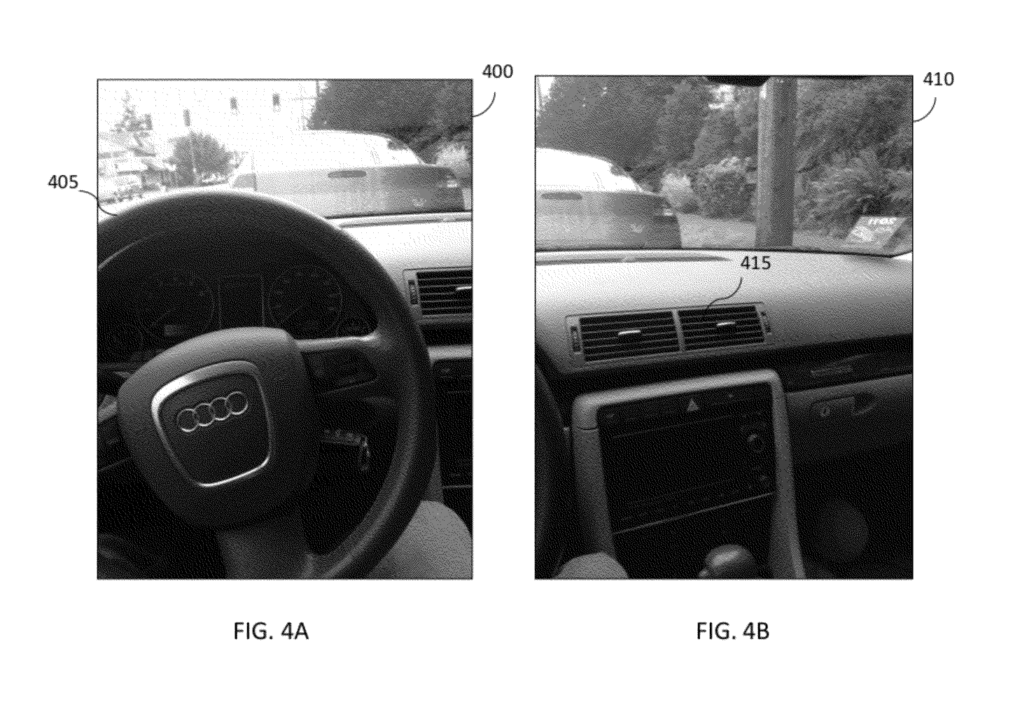

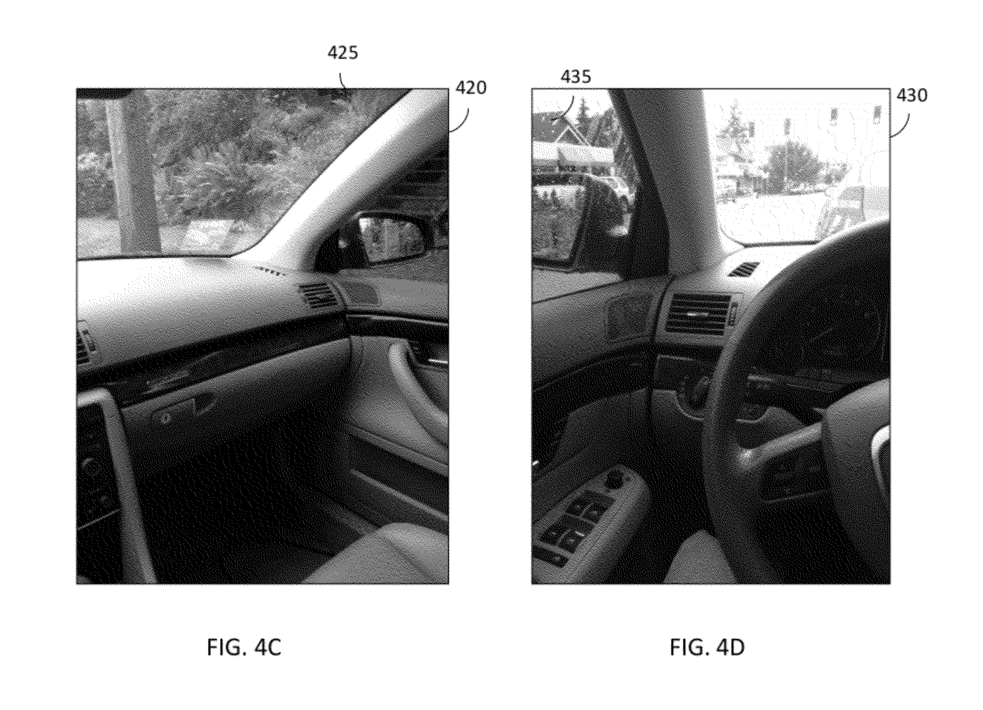

For example, FIGS. 4A-4D are screen displays illustrating image information captured and/or utilized by the system, such as information associated with objects, features or other content within images that indicate a mobile device is within a location associated with or attributed to a driver of a vehicle, or within a location associated with a passenger of a vehicle, among other things.

FIG. 4A depicts a captured image 400 that includes a steering wheel 405, which, when identified by the system, indicates that the mobile device is located within a driver's side of a vehicle. Additionally, the system may identify the steering wheel 405 as being centered within the image and barely skewed from the camera, indicating the steering wheel 405 is close to and directly, or nearly directly, behind the camera that captured image, and thus the mobile device is located at the driver's side of the vehicle.

FIG. 4B depicts a captured image 410 that includes one or more center console features 415, which, when identified by the system, indicates that the mobile device is located within a driver's side of a vehicle. Additionally, the system may identify the console features 415 as being somewhat skewed from the camera, indicating the camera is located to the left of the console, and thus the mobile device is located at the driver's side of the vehicle.

FIG. 4C depicts a captured image 420 that includes one or more passenger side features 425 located within a region that is at the right edge of the image 420 and of a certain size indicating the passenger side features 425 are not next to the camera of the mobile device, which, when identified by the system, indicate that the mobile device is located at the driver's side of the vehicle.

FIG. 4D depicts a captured image 430 that includes one or more exterior objects 435 located at a left edge of the image 430, which, when identified by the system, indicates that the mobile device is located at the driver's side of the vehicle. Of course, one or ordinary skill in the art will realize that the system may identify other objects, features, colors, textures, shapes, vanishing points, and so on, when determining whether a mobile device is located within a driver's side of a vehicle.

In some examples, the system utilizes additional information, such as device orientation information, when identifying objects within captured images. For example, the system may consider an image, or, in some cases, a group of images such as a short video clip, to be indicative of a location associated with a driver when light travels in an image from right to left (e.g., light traveling relatively from view in a windshield to the driver's side window), when an object is within the image when the device is at a certain orientation (e.g., the shift knob is in the image while the device is turned towards the middle of the vehicle), and so on.

In some cases, the system may utilize images associated with a specific vehicle, and determine the location of a mobile device within a vehicle based on a comparison of images taken from the surroundings of the mobile device to the stored images. For example, the system may receive and/or store information identifying the type of car a user is driving, receive images associated with the type of car, and perform comparisons utilizing the received images. In some cases, the receive images may be standard images of an interior of a vehicle, such as images of a dashboard, a steering wheel, a console, and so on. In some cases, the received images may be images of such components representing images taken at certain orientations of a camera with respect to the components, or with respect to the type of camera itself. For example, the received images may be similar to images expected to be taken by a user holding his/her mobile phone while inputting a text message. The received images may be stored locally within a mobile device, stored remotely from the mobile device, and so on.

The system may consider the application or type of use when considering what objects and other information to utilize when determining the location of a mobile device within a vehicle. For texting applications, where a user generally holds a mobile device with the back of the device generally facing the front of the vehicle (that is, the front of the device generally faces opposite the direction of movement), the system may attempt to identify certain objects that would be indicative of such an orientation (i.e., dashboard elements). However, for calling applications, where a user generally holds a mobile device to his/her ear (that is, the side of a mobile device would be in the general direction of movement), the system may attempt to identify certain objects that would be indicative of an orientation of the device being held near the user's left ear (i.e., a window being very close within the image) or near the user's right ear (i.e., a view of the passenger side dashboard, a view of the passenger seat and/or passenger door at a distance within the image, and so on). Of course, the system may consider other combinations of orientation, use, and information in determining the location of the mobile device.

Referring back to routine 300, when the identified objects indicate the device is at a location associated with a driver, routine proceeds to step 360, and the system performs an action, such as disabling a functionality of a texting or calling application associated with the device. In some cases, the system, in step 370 may cause the device to indicate the disablement or modification to the user, or perform other actions.

In some examples, when the identified objects do not indicate the device is at a location associated with the driver, routine 300 proceeds to step 350 and determines if the identified objects indicate the mobile device is at another location within the vehicle (i.e., the identified objects show a seat back indicative of a rear location in the vehicle). When the identified objects indicate the mobile device is at another location within the vehicle, routine 300 proceeds to step 355 and allows current use of the device. When the identified objects do not indicate the mobile device is at another location within the vehicle, routine 300 proceeds back to step 320, and attempts to accurately identify the location of the mobile device.

The system may perform routine 300 periodically, continually, or when prompted. For example, the system may perform routine 300 when the mobile device is traveling above a certain rate of speed, when the mobile device is traveling at a certain rate of speed and the mobile device moves in a manner that indicates use of the mobile device, such as movement from a rest position to a user's ear, when an application receives input into the device, such as text input, and so on.

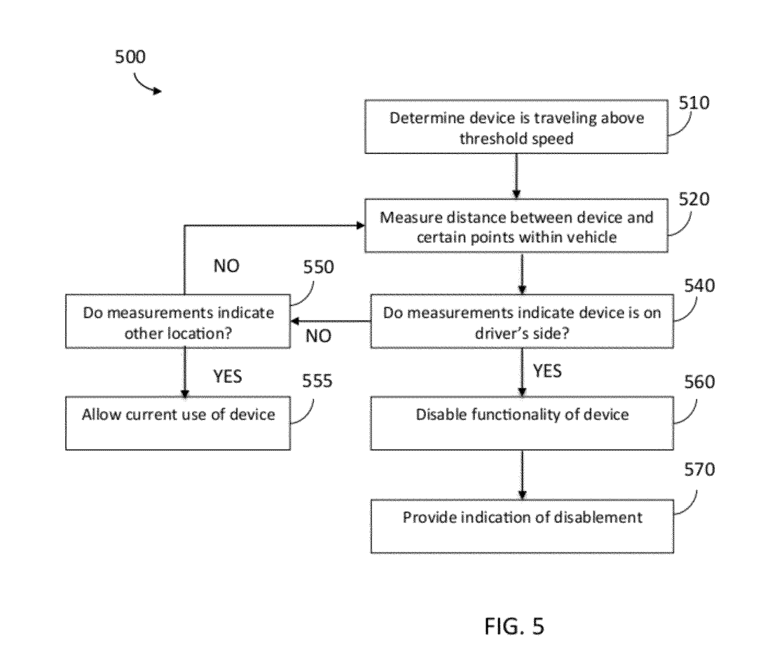

FIG. 5 is a flow diagram illustrating a routine for disabling operation of a mobile device based on location detection. In step 510, the system, via a vehicle determination component 210, determines a mobile device is traveling above or within a threshold rate of speed.

In step 520, the system, via a location determination component, measures distances between the mobile device and various points within the vehicle. The system, via a distance measurement component, may measure the distances in a variety of ways. For example, the system may utilize a range finder, an RFID reader, a Bluetooth component, a 2.4 GHz transceiver, an audio signal generator, or other components capable of measuring distance. The system may include one or more stickers, decals, integrated components, RFID tags and other RF reflector devices, and/or other components that may be placed within the vehicle, and measure distance to the specifically placed components.

For example, the system, via the location determination component, transmits a non-directional RF signal outwards from the mobile device. The transmitted RF signal bounces off a directional antenna array, such as an RF reflector made of flex and/or PCB components that is attached (e.g. using an adhesive) to one or more interior areas of a vehicle. The reflected signal travels back to the mobile device as a focused RF signal having a signal strength that is a function of an orientation of the reflector with respect to the mobile device and/or a distance between the mobile device and the reflector. The mobile device receives the focused RF signal and determines a distance and/or range of possible distances between the reflector and the mobile device based on the signal strength of the received RF signal.

In step 530, the system determines if the distance measurements indicate the mobile device is within a location associated with the driver of the vehicle. For example, if a vehicle is split into four quadrants, the system may determine the mobile device is within the upper left quadrant based on receiving 100 distance measurements that indicate the mobile device was closer to a sticker in the upper quadrant than a sticker in the upper right quadrant 95% of the time.

In some cases, the system determines the location of a mobile device based on a single distance measurement. In some cases, the system determines the location of a mobile device based on multiple distance measurements. For example, the system may take multiple distance measurement between a mobile device and multiple points within the vehicle, and average or otherwise analyze the measurements to determine whether the mobile device is in a location associated with a driver of a vehicle.

Referring back to routine 500, when the distance measurements indicate the device is at a location associated with a driver, routine proceeds to step 540, and the system performs an action, such as disabling a functionality of a texting or calling application associated with the device. In some cases, the system, in step 550 may cause the device to indicate the disablement or modification to the user, or perform other actions.

When the identified objects do not indicate the device is at a location associated with the driver, routine 500 proceeds to step 560 and determines if the identified objects indicate the mobile device is at another location within the vehicle (i.e., the identified objects show a seat back indicative of a rear location in the vehicle). When the identified objects indicate the mobile device is at another location within the vehicle, routine 500 proceeds to step 565 and allows current use of the device. When the identified objects do not indicate the mobile device is at another location within the vehicle, routine 500 proceeds back to step 520, and attempts to accurately identify the location of the mobile device.

The system may perform routine 500 periodically, continually, or when prompted. For example, the system may perform routine 500 when the mobile device is traveling above a certain rate of speed, when the mobile device is traveling at a certain rate of speed and the mobile device moves in a manner that indicates use, such as movement from a rest position to a user's ear, when an application receives input into the device, such as text input, and so on.

### Other Information Used to Identify Use of a Mobile Device by a Driver

In some examples, some or all of the devices, components and/or routines described herein may implement the following:

Use of audio signatures/frequency matching to identify that the user is in a moving vehicle as an alternative to GPS, such as using an audio signature of a specific moving vehicle or identifying certain frequencies and/or amplitudes of detected audio signatures associated with a vehicle's speed to determine that the vehicle is traveling above a threshold speed;

Use of cell tower triangulation to identify that a user is moving at a speed associated with automobile travel as an alternative to GPS; and/or

Use of transmitted and reflected visible or infrared light as indication of location of the phone within the automobile. For example, a reflector could be placed within the car that would provide an infrared or visible light signature identifiable by the phones camera to establish location of the phone within the car, or, alternatively, a visible or infrared light source could be located in the interior of the car to provide location information to the phone via its' camera.

Of course, one of ordinary skill in the art will realize that the system may use any and all of the information described herein, alone or in combination, when attempting to identify that a driver of a vehicle is using a mobile phone or other mobile device.

### Use of the System

As discussed herein, the system may be provided by an entity, such as an insurance company, telecommunications provider, car manufacturer, enterprise (e.g., a trucking company, bus company, railroad company, airline, and so on) and so on, that may provide incentives or other services to users that employ the system in their mobile devices and/or vehicles. For example, an insurance company or other entity may provide discounted rates to users of the system, by periodically pinging the system to receive updates regarding the use or operation of the system within the user's device. The entity may retrieve information from the system associated with use of the system, and provide discounts based on the retrieved information. For example, when generating a bill for a user, the entity may transmit information to the user's device, causing the system to operate one of more of the routines described herein. The system may transmit back an indication that the system was enabled and/or the routines were performed, and the entity, in response to the indication, may (automatically) adjust the bill with a discounted rate.

In some examples, in addition to providing an entity with use information in order to provide insurance discounts or other benefits to a user, the system may facilitate the collection and/or capture of information that provides insight into a user's driving habits, driving history, and so on. For example, the system may collect speed and location data in combination with information associated with a use of a mobile device by a user in order to provide an engaged entity, such as an insurance company, with information that may be used in various risk algorithms utilized by the entity when setting insurance premiums for a user, among other things. Thus, in some examples, an insurance company or other entity that performs risk assessments, may utilize some or all of the information captured by the system when determining a level of risk to attribute to a user, when setting insurance premiums, when setting insurance rates for a group of users, and so on.

### Preventing Tampering of the Device or Operation of the System

There may be times when users will attempt to prevent the system from functioning. For example, they may tape over or cover a camera of the device while driving a vehicle. As described herein, the system may perform various routines to verify active use of the system, and when use is not verified, perform actions to remedy misuse.

### Example Use Scenarios

A parent of a new driver downloads the system onto the new driver's smart phone, inputting information that identifies the type of car often operated by the new driver. The new driver, during operation of the car, attempts to input a text message into his smart phone. The system detects the operation of the car based on the car's rate of speed and initiates a process to determine the location of the smart phone based on the launching of a messaging application. The system takes a number of images of the surrounding environment within the car, and matches some of the images to images associated with the type of car. The system disables operation of the messaging application and informs the new driver that they cannot send a text message while driving.

A driver receives a call and picks up her cell phone while driving on the highway. The system, executing in the background while the driver's car is on the highway, transmits a RF signal to a point within the vehicle based on the motion of the cell phone during the pick up of the call. The system identifies the location of the cell phone as being in an area associated with the driver, and disables the call. The system informs the driver that the call is disabled.

In addition to texting and calling applications, a mobile device may utilize the system to disable, redirect, and/or otherwise prevent the use of various applications, apps, or other functions supported by a mobile device, such as a smart phone, tablet computer, and so on. Some applications include web browsers, social networking applications, games, mapping systems, directly provided content (e.g. streaming video, video conferencing, and so on), mail applications, applications that require use of a keyboard and/or other input mechanisms, and/or any applications that may distract a person controlling a vehicle by requiring the person to look at their mobile device.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While many embodiments described above employ software stored on the mobile device (either before being given to a subscriber, or during a subscriber call), the scripts and other software noted above may be hard coded into the mobile device (e.g. stored in EEPROM, PROM, etc.). Further, the above functionality may be implemented without scripts or other special modules.

The teachings of the system provided herein can be applied to other systems, not necessarily the system described above. The elements and acts of the various embodiments described above can be combined to provide further embodiments.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the local-based support system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. Accordingly, the inventors reserve the right to add additional claims after filing the application to pursue such additional claim forms for other aspects of the system.

We claim:

1. A method performed by a mobile device for disabling use of the mobile device, the method comprising:
detecting the mobile device is moving at a rate of speed above or within a threshold rate of speed;
determining a location of the mobile device within the vehicle by capturing information associated with the vehicle using an audio component, an optical component, or a distance measurement component of the mobile device; and
performing an action to modify a functionality of the mobile device when the determined location is associated with a driver of the vehicle.

2. The method of claim 1, wherein determining a location of the mobile device within the vehicle includes:
capturing an image of an interior of the vehicle using a camera of the mobile device; and
identifying within the captured image an object associated with the location associated with a driver of the vehicle.

3. The method of claim 1, wherein determining a location of the mobile device within the vehicle includes:
capturing an image of an interior of the vehicle using a camera of the mobile device;
comparing at least a portion of contents of the captured image with a set of images associated with a make or maker of the vehicle; and
matching the portion of the contents of the captured image with at least a portion of contents of one or more images within the set of images associated with the make or maker of the vehicle.

4. The method of claim 1, wherein determining a location of the mobile device within the vehicle includes:
measuring a distance between the mobile device and a point within an interior of the vehicle; and
identifying that the measured distance is associated with the mobile device being in the location associated with the driver of the vehicle.

5. The method of claim 1, wherein performing an action to modify a functionality of the mobile device when the determined location is associated with a driver of the vehicle includes disabling use of a texting application of the mobile device.

6. The method of claim 1, wherein performing an action to modify a functionality of the mobile device when the determined location is associated with a driver of the vehicle includes disabling use of a calling application of the mobile device.

7. A system for disabling functionality of a mobile device within a vehicle, the method comprising:
a speed detection component, wherein the speed detection component is configured to detect the mobile device is moving at a rate of speed above or within a threshold rate of speed;
a location determination component, wherein the location determination component is configured to determine a location of the mobile device within the vehicle by capturing information associated with the vehicle using an audio component, an optical component, or a distance measurement component of the mobile device; and
an action component, wherein the action component is configured to perform an action to modify the functionality of the mobile device when the determined location is associated with a driver of the vehicle.

8. The system of claim 1, wherein the location determination component includes:
an image capture component, wherein the image capture component is configured to capture an image of an interior of the vehicle using a camera of the mobile device; and
an identification component, wherein the identification component is configured to identify within the captured image an object located within the location associated with a driver of the vehicle.

9. The system of claim 1, wherein the location determination component is a distance measurement component that is configured to:
measure a distance between the mobile device and a point within an interior of the vehicle by transmitting a non-directional RF signal outwards from the mobile device; and
identify that the measured distance is associated with the mobile device being in the location associated with the driver of the vehicle based on a signal strength of a focused RF signal received by the mobile device.

10. The method of claim 1, wherein the action component is configured to disable use of a texting application of the mobile device.

11. The method of claim 1, wherein the action component is configured to disable use of a calling application of the mobile device.

12. A computer-readable storage medium whose contents, when executed by a processor of a mobile device, cause the mobile device to perform a method for determining that a driver of a vehicle is using the mobile device, the method comprising:
determining that the vehicle is moving at a speed above a threshold rate of speed;
capturing an image of the vehicle using a camera of the mobile device; and
determining that the mobile device is within a location associated with the driver of the vehicle based on content within the captured image.

13. The computer-readable storage medium of claim 12, further comprising:
performing an action to disable use of an application of the mobile device based on the determination that the mobile device is within a location associated with the driver of the vehicle and based on the determination that the vehicle is moving at a speed above the threshold rate of speed.

14. The computer-readable storage medium of claim 12, further comprising:
performing an action to disable use of a text input application of the mobile device based on the determination that the mobile device is within a location associated with the driver of the vehicle and based on the determination that the vehicle is moving at a speed above the threshold rate of speed.

15. The computer-readable storage medium of claim 12, further comprising:
performing an action to disable use of a voice call application of the mobile device based on the determination that the mobile device is within a location associated with the driver of the vehicle and based on the determination that the vehicle is moving at a speed above the threshold rate of speed.

16. The computer-readable storage medium of claim 12, wherein determining that the mobile device is within a location associated with the driver of the vehicle based on content within the captured image includes identifying at least a portion of a dashboard of the vehicle within the captured image.

17. The computer-readable storage medium of claim 12, wherein determining that the mobile device is within a location associated with the driver of the vehicle based on content within the captured image includes identifying at least a portion of a steering wheel of the vehicle within the captured image.

18. The computer-readable storage medium of claim 12, wherein determining that the mobile device is within a location associated with the driver of the vehicle based on content within the captured image includes identifying at least one light region and one dark region within the captured image.

19. The computer-readable storage medium of claim 12, determining that the mobile device is within a location associated with the driver of the vehicle based on content within the captured image includes identifying at least a portion of a middle console in a certain location within the captured image.

20. The computer-readable storage medium of claim 12, further comprising:
receiving information associated with an orientation of the mobile device; and
performing an action to disable use of an application of the mobile device based on the determination that the mobile device is within a location associated with the driver of the vehicle, based on the received orientation information, and based on the determination that the vehicle is moving at a speed above the threshold rate of speed.
